(19) United States
(12) Patent Application Publication
(10) Pub. No.: US 2008/0264025 A1
(43) Pub. Date: Oct. 30, 2008

(54) Header height sensor apparatus for a header of an agricultural harvester

(76) Inventors: Benjamin W. Ditchcreek, Reinholds, PA (US); Blaine R. Noll, Fleetwood, PA (US); Irwin D. McIlwain, Lancaster, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/150,563

(22) Filed: Apr. 29, 2008

Related U.S. Application Data
(60) Provisional application No. 60/926,873, filed on Apr. 30, 2007.

(51) Int. Cl. A01D 47/00; A47H 1/14; A01D 41/127

(52) U.S. Cl. 56/10.2 E; 248/251

(57) ABSTRACT

A plurality of elongate mounting brackets mounted in cantilever relation on a frame of a header at sidewardly spaced locations across at least a portion of a width of the header, respectively, support a sensor rod for rotation about its axis. Each of the brackets has a free end including a bearing having a bore therethrough which receives the sensor rod, at least some of the bearings being self-aligning bearings. The self-aligning capability enables accommodating irregularities in the mounting locations for the brackets, and also bends, flexure and other deformities of the header frame and sensor rod, for achieving free rotatability of the sensor rod. This mounting arrangement also facilitates installation by one person, from the bottom side of the header, both initially and in the field. Additionally, the brackets can include features for aligning the bores of the bearings, to facilitate the installation and free rotation of the sensor rod when installed.

This application claims the benefit of U.S. Provisional Application No. 60/926,873, filed Apr. 30, 2007.

### TECHNICAL FIELD

This invention relates generally to a sensor apparatus for a header height control for an agricultural harvester, and more particularly, to an improved sensor apparatus including a mounting arrangement for a rotatable sensor rod extending across at least a portion of the header that facilitates installation and free rotation of the rod, for improved sensor operation, including when a sensor rod is bent or deformed, for instance, as a result of contact with rocks or other foreign objects on a field, or the rod and/or the header is flexed.

### BACKGROUND ART

U.S. Provisional Application No. 60/926,873, filed Apr. 30, 2007, is incorporated herein in its entirety by reference.

Header height controls which utilize a sensor having an elongate sensor rod which extends along all or a substantial portion of the sideward width or extent of a header, are well known. Typical sensors have sensor arms on the rod at spaced locations therealong, which contact or rest on ground following elements and cause rotation of the rod, to effect a change of state of the sensor. It is crucial for accurate ground sensing, for the sensor rod to have the capability to freely rotate for following the movements of the ground following elements, for translating such movements into sensor inputs.

As an example of a problem that can be encountered, if the sensor rod does not freely rotate, e.g., the rod is bent, it can be forced by a ground following element into a more upward rotational position, and then remain in that position, even after the ground following element has moved downward responsive to a ground contour change. This can cause the height control to raise the header to its highest position, such that the crops will be cut at a level higher than is desired. To overcome this problem in the field, the operator may be required to override or disable the height control. And, correction of the problem will result in downtime, expense and additional problems.

In this latter regard, some known sensor rods require two persons to install (one on the floor side of the header, and one on the bottom side, which can be problematic when installing in the field. Alignment of the components for installation can also be difficult.

Thus, what is sought is sensor apparatus for a height control system of a header for an agricultural harvester, which overcomes one or more of the problems set forth above.

### SUMMARY OF THE INVENTION

What is disclosed is sensor apparatus for a height control system of a header for an agricultural harvester, which overcomes one or more of the problems set forth above.

According to a preferred aspect of the invention, the height control sensor utilizes a plurality of elongate mounting brackets mounted in cantilever relation on a frame of a header at sidewardly spaced locations across at least a portion of a width of the header, respectively. Each of the brackets has a free end spaced from the frame, the free end of each of the brackets includes a bearing thereon having a member including a bore therethrough. At least some of the bearings are self-aligning bearings wherein the member including the bore is supported for pivotal movement about a center of the bore, the centers of the bores being held in alignment along a sidewardly extending axis by the brackets. A sensor rod extends through the aligned bores so as to be supported by the brackets along the sidewardly extending axis for substantially free rotation about the axis. The sensor rod includes a plurality of sensor arms extending laterally therefrom at sidewardly spaced locations therealong. Each sensor arm is disposed for contacting an element of the header configured so as to be movable upwardly and downwardly with contours of a surface over which the header is moved. As a result, the sensor rod will be free to be rotated about the axis by the upward and downward movements of the uppermost element or elements. A sensor is connected to the sensor rod and operable for sensing the rotations of the rod.

As a non-limiting example, the sensor can be connected to the sensor rod utilizing a suitable linkage. As another example, the sensor can be mounted adjacent to an end of the header, and connected to other elements of the header height control in the customary manner, as well known in the art.

According to another preferred aspect of the invention, the elements of the header movable upwardly and downwardly with surface contours, comprise skid plates which ride along the ground. The sensor rod and mounting apparatus are preferably disposed above the skid plates, or particularly, above support arms in connection therewith, and below a floor of the header. As noted above, it is contemplated that accidental bending or other deformation of the sensor rod can occur, as a result of contact with rocks, logs and other hard objects that may be present on the ground over which the header passes. An important advantage of the self-aligning bearings of the invention, is that the pivotable bearing members thereof which carry the sensor rod, can individually self-adjust, e.g., pivot and rotate, to align with any bent portions of the sensor rod, so as to still allow free rotation of the rod about the axis. This is also true for flexure and other deformations of the sensor rod.

According to one preferred embodiment of the invention, the mounting brackets are individually adjustable in length, e.g., utilizing spacers, for aligning the bearings of the individual brackets with the bearings of others of the brackets. The mounting brackets can also be adjustably positionable rotationally about a longitudinal axis thereof, to facilitate aligning the bearings. As a result, the installation can accommodate misalignments of the locations on the frame where the brackets are mounted resulting from damage, manufacturing tolerance, and flexure, and also bends or other deformations and flexure of the sensor rod, to allow free rotation of the rod when installed.

According to another preferred embodiment of the invention, the mounting brackets are connected to the frame of the header in a manner to automatically align the bearings. This can utilize, for instance, a self-aligning carriage bolt or the like. In this way, the variances in the frame and sensor rod are accommodated by the bearings, to allow the sought after free rotation of the sensor rod.

According to still another preferred embodiment of the invention, each of the mounting brackets includes a free end including a concavity for receiving the pivotable member of the bearing, so as to allow the free pivotal movement thereof, without binding and the like, or otherwise impeding the free rotation of the sensor rod.

### BRIEF DESCRIPTION OF THE DRAWINGS

FIG. 1 is a fragmentary perspective view of a representative header including a header height control sensor apparatus according to the present invention;

FIG. 2 is a simplified a bottom view of the header of FIG. 1;

FIG. 3 is a fragmentary perspective exploded view, illustrating elements of the sensor apparatus of the invention, including a representative mounting bracket of the apparatus;

FIG. 4 is a side view illustrating an alternative mounting bracket of the invention; and

FIG. 5 is a bottom view of the bracket of FIG. 4.

### DETAILED DESCRIPTION OF THE INVENTION

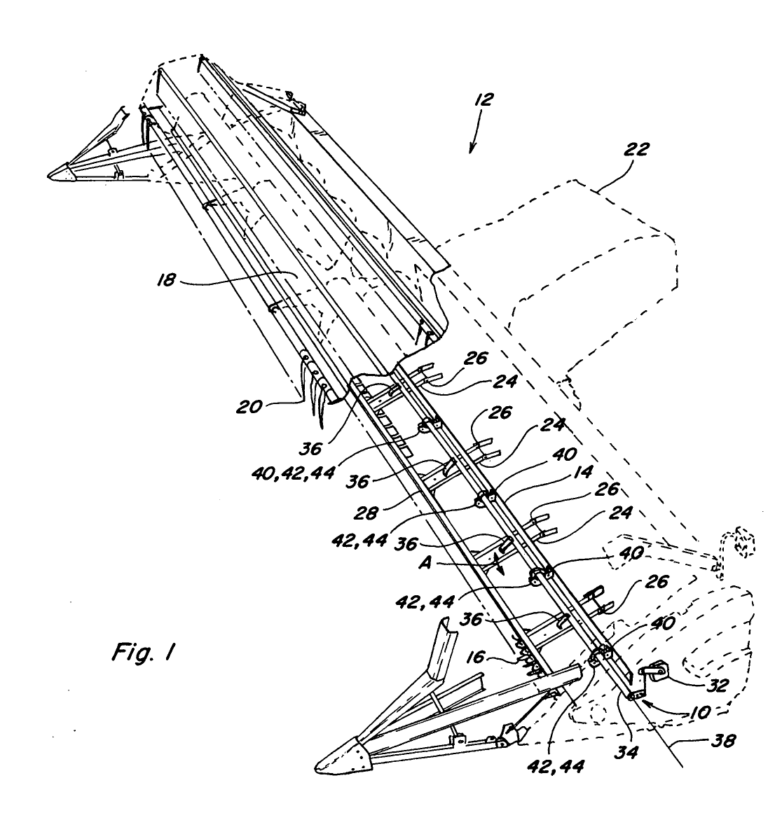

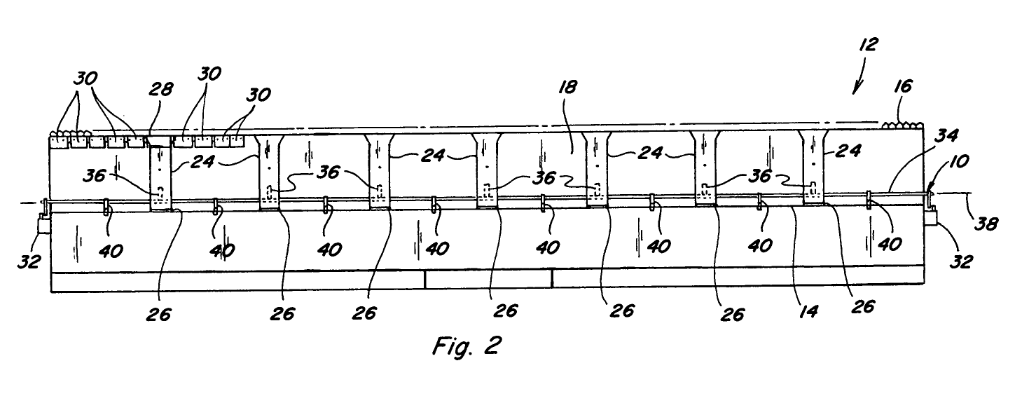

Referring now to the drawings, in FIGS. 1 and 2, a header height control sensor apparatus 10 constructed and operable according to the teachings of the present invention, is shown incorporated on a header 12 for an agricultural harvester (not shown).

Header 12 is of generally conventional construction, including an elongate frame 14 supporting cutting apparatus 16 along a front edge thereof, which cutting apparatus 16 in this embodiment comprises a conventionally constructed sickle reciprocatingly operable in the well-known manner for severing crops from a field as header 12 is moved forwardly thereover. Header 12 includes a floor 18 (underside shown in FIG. 2) extending rearwardly from cutting apparatus 16, and onto which the crops will be conveyed by a reel 20, also in the well-known manner. The crops will then be conveyed toward the center of the header by additional conveyor apparatus, e.g., auger or draper belt (not shown), for induction into a feeder 22 which will convey the crops into a harvester on which the header is mounted.

Cutting apparatus 16 is preferably constructed so as to have limited flexibility from end to end, for purposes including accommodating and conforming at least generally to varying ground contours at different locations along the width. Cutting apparatus 16 is additionally preferably supported for upward and downward movement beneath floor 18 (as denoted by arrow A in FIG. 1), for further accommodating changing ground contours, by a plurality of support arms 24 disposed beneath floor 18. Each support arm 24 is pivotally connected at a rear end thereof to frame 14, by a pivot joint 26, for enabling the movements A. A forward end of each support arm 24 is connected to a bar 28 that extends the width of header 12 and carries cutting apparatus 16, and which also supports a row of skid plates 30 extending across the width of the header and configured for contacting the ground or other surface therebeneath. Such contact with raised portions of the ground or other surface beneath the header will effect upward movements of the affected skid plate or skid plates 30 making the contact, that portion of bar 20 in the vicinity thereof, and also the support arm or arms 24 carrying the affected skid plate or plates. And, when the ground contour decreases in height, the affected skid plate or plates 30 will follow the decrease, to pivot arm or arms 24 downwardly. As a result, arms 24 provide a reliable ground sensing capability, e.g., indicators of ground contour changes, and serve as indicators of a need to adjust the height position of header 12.

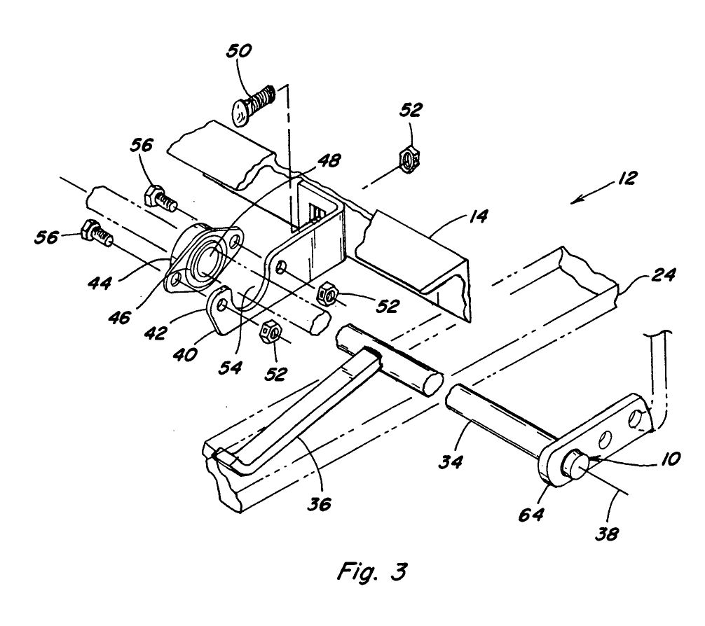

Referring also to FIG. 3, header height control sensor apparatus 10 is configured and operable according to the teachings of the present invention, for following and sensing upward and downward movements of support arms 24, and outputting signals representative thereof to a header height control (not shown) of the harvester. Sensor apparatus 10 includes a sensor 32 on one or both ends thereof, for this purpose. In response, the height control is automatically operable to control a fluid cylinder or cylinders (not shown) in connection with feeder 22, to raise or lower header 12 as required for maintaining cutting apparatus 16 at a desired level above the ground surface.

Sensor apparatus 10 includes one or more elongate sensor rods 34 extending sidewardly across the width of header 12 in connection with sensor or sensors 32, and including a plurality of sensor arms 36 extending laterally from the rod at spaced locations therealong. Sensor rod or rods 34 is/are preferably disposed beneath floor 18 of header 12 and generally above support arms 24 and skid plates 30, with sensor arms 36 being positioned so as to extend forwardly to contact the respective support arms 24. Each sensor rod 34 is supported for rotation about an axis 38 extending longitudinally therethrough, such that support arms 24 are allowed to move upwardly and downwardly in following relation to the upward and downward movements of support arms 24. In this regard, sensor arms 36 are preferably L-shaped members, having free ends which normally rest on respective arms 24, although it is also contemplated that alternative designs could be used as desired or required for a particular application.

Here, it should be noted that it is a sought after feature of the present invention, that sensor rod or rods 34 be freely rotatable about axis 38, particularly, so as to closely follow the movements of the uppermost one or ones of the support arms 24, and so as not to bind or stop in a raised position, not supported by at least one raised arm 24. As a result, the rotational position of sensor rod 34 will be determined by the uppermost skid plate or plates 30 and associated support arm or arms 24. This is achieved according to the invention by supporting sensor rod or rods 34 using a plurality of elongate mounting brackets 40 mounted in cantilever relation on frame 14 of header 12 at sidewardly spaced locations across the width of the header, respectively. Each bracket 40 has a free end 42 spaced from the point of attachment to the frame, which includes a bearing 44 thereon having a member 46 including a bore 48 therethrough, as best illustrated in FIG. 3. At least some, and preferably all, of bearings 44 are self-aligning bearings wherein member 46 including bore 48, is supported for pivotal movement about the center of member 46, bores 48 when centered being aligned along axis 38. Sensor rod 34 extends through bores 48 of the bearings so as to be supported by brackets 40 for substantially free rotation about axis 38.

As noted above, accidental bending or other deformation of sensor rod 34 can occur, as a result of such occurrences as contact with rocks, logs and other hard objects that may be present on the ground over which the header passes. Sensor rod 34, and/or frame 14, can also flex. To accommodate these conditions, pivotable members 46 of bearings 44 have the capability to individually self-adjust, e.g., pivot and rotate, to align with adjacent bent portions of sensor rod 34, so as to still allow free rotation of the sensor rod.

Preferably, mounting brackets 40 are connected to frame 14 in a manner to automatically align bearings 44 along axis 38. This can be achieved, for instance, by attaching brackets 40 using a single self-aligning carriage bolt 50 or the like, securable with a nut 52. Brackets 40 and the portion of frame 14 to which the brackets are to be attached, here, a metal angle, can be provided with suitably shaped, e.g., rectangular, holes alignable for receiving bolts 50. In this way, manufacturing and other variances in the relative positions of frame 14 and sensor rod 34 are accommodated by bearings 44, to allow the free rotation of sensor rod 34. Brackets 40 can have an L-shape or other suitable configuration for facilitating the alignment and attachment.

Also preferably, free end 42 of each bracket 40 preferably includes or forms a concavity 54, sized and shaped for receiving member 46 of bearing 44 when mounted thereto, for facilitating and accommodating pivotal movements of member 46, as required for allowing the free rotation of rod 34. Bearings 44 can be suitably mounted to free ends 42 of brackets 40, respectively, for instance, utilizing screws 56 and additional nuts 52. Holes through bearings 44 and free ends 42 can have close tolerances for precise positioning of the bearings, for alignment with axis 38.

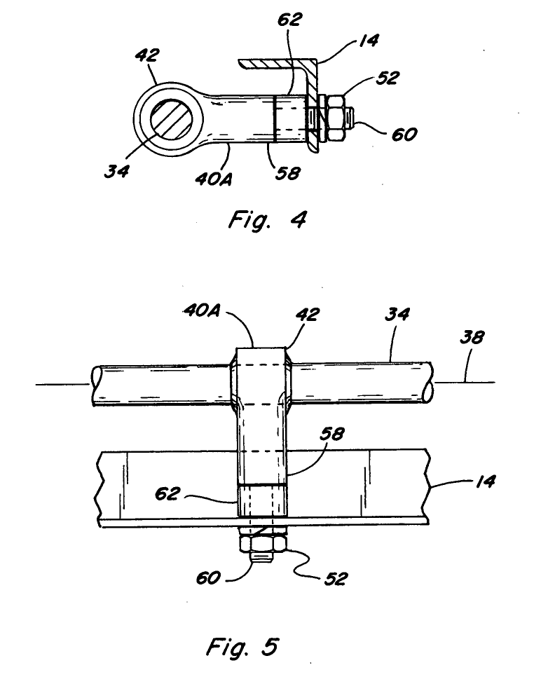

Referring also to FIGS. 4 and 5, an alternative mounting bracket 40A is illustrated, like parts of bracket 40A and bracket 40 being identified by like numbers. Mounting bracket 40A, like bracket 40, includes a free end 42 carrying a self-aligning bearing 44, constructed and operable in the above-described manner, for supporting sensor rod 34. As a nonlimiting example, bearings 44 can comprise commercially available spherical bearings of suitable size and including suitable characteristics, such as heat and corrosion resistance, so as to be suitable for being subjected to a painting process involving oven baking, and exposure to the outdoor environment over a long period of time. As an additional feature, mounting bracket 40A has a mounting end 58 configured to include a threaded stud or other fastener 60 over which a spacer 62 can be fitted, for setting a distance between bearing 44 and frame 14, for aligning sensor rod 34 with axis 38. Fastener 60 can extend through a hole through frame 14, and can be secured with a mating fastener, such as a nut 52. Additionally, this enables rotation of bracket 40A about the center of fastener 60, as required for achieving the alignment with axis 38. Here, an advantage is that each bracket 40A can utilize a different size spacer 62, as required for achieving the alignment. This can be useful, when the brackets are mounted at locations on frame 14 which are damaged, e.g., bent or otherwise deformed, or are at an outer limit of a manufacturing tolerance.

The end or ends of sensor rod 34 are preferably connected to sensor or sensors 32, in the conventional, well-known manner. Here, this utilizes an adjustable linkage 64 (FIG. 3) which will translate rotations of rod 34 to sensor 32 as is well known in the art.

In light of all the foregoing, it should thus be apparent to those skilled in the art that there has been shown and described a sensor apparatus for a header height control, which achieves one or more of the objectives sought therefor. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. Sensor apparatus for a header height control for an agricultural harvester, comprising:
a plurality of elongate mounting brackets mounted in cantilever relation on a frame of a header at sidewardly spaced locations across at least a portion of a width of the header, respectively, each of the brackets having a free end spaced from the frame, the free end of each of the brackets including a bearing thereon having a member including a bore therethrough, at least some of the bearings being self-aligning bearings wherein the member is supported for pivotal movement about the axis, and the bores of the bearings being aligned along a sidewardly extending axis;
a sensor rod extending through the sidewardly aligned bores of the self-aligning bearings so as to be supported by the brackets along the sidewardly extending axis for substantially free rotation about the axis, the sensor rod including a plurality of sensor arms extending laterally therefrom at sidewardly spaced locations therealong, each of the sensor arms being disposed for contacting an element of the header configured so as to be movable upwardly and downwardly with contours of a surface over which the header is moved, such that the sensor rod will be rotated about the axis by the upward and downward movements of at least one of the elements; and
a sensor connected to the sensor rod and operable for sensing the rotations of the rod.

2. Sensor apparatus of claim 1, wherein at least substantially all of the bearings are self-aligning bearings.

3. Sensor apparatus of claim 1, wherein the members of the self-aligning bearings are pivotable during rotation of the rod, for accommodating bends in the rod and flexure thereof.

4. Sensor apparatus of claim 1, wherein the free ends of the brackets each include a concavity through which the rod extends.

5. Sensor apparatus of claim 1, wherein the mounting brackets are connected to the frame with carriage bolts, respectively, for aligning the bores of the bearings thereof with the axis, respectively.

6. Sensor apparatus of claim 1, wherein the sensor is connected to the rod by an adjustable linkage.

7. Sensor apparatus of claim 1, wherein at least one of the mounting brackets is mounted to the frame with a spacer therebetween for aligning the bore of the bearing on the free end of the bracket with the bearings on others of the brackets.

8. A mounting bracket for a sensor rod for a height control system of a header for an agricultural combine, comprising:
a base mountable to a frame of a header, and a free end opposite the base, the free end carrying a self-aligning bearing having a pivotable member having a bore therethrough configured for receiving a sensor rod, and the base being configured for adjustably positioning the bracket for positioning the bore of the pivotable member in alignment with the sensor rod.

9. The mounting bracket of claim 8, wherein the base comprises a spacer for adjusting a distance of the bore of the pivotable member to the frame of the header.

10. The mounting bracket of claim 8, wherein the base is configured to be rotatably positionable on the frame for aligning the bore of the pivotable member with the sensor rod.

11. The mounting bracket of claim 8, wherein the free end of the bracket includes a concavity and the self-aligning bearing is mounted on the free end with the pivoting member disposed at least partially in the concavity.

12. A header for an agricultural harvester, comprising:
an elongate frame supporting cutting apparatus along a front edge thereof, a floor extending rearwardly from the cutting apparatus, and a plurality of elements supported below the floor at spaced locations therealong for movement upwardly and downwardly relative to the header for following a contour of a surface as the header is moved thereover; and
a header height control sensor including an elongate sensor rod extending longitudinally along the header generally between the floor and the elements, the sensor rod including a plurality of sensor arms extending laterally therefrom at spaced locations therealong so as to rest on at least an uppermost one of the elements and move upwardly and downwardly therewith, for rotating the sensor rod responsive to the upward and downward movements, the sensor rod being supported by a plurality of self-aligning bearings at aligned, spaced locations therealong, so as to be substantially freely rotatable by the sensor arms, each of the self-aligning bearings being supported on a free end of a mounting bracket attached to the frame, respectively, and a sensor connected to the sensor rod and operable for sensing the rotations of the rod.

13. The header of claim 12, wherein the bearings are pivotable during rotation of the rod, for accommodating bends and flexure of the rod.

14. The header of claim 12, wherein the free ends of the brackets each include a concavity through which the sensor rod extends.

15. The header of claim 12, wherein the mounting brackets are connected to the frame with carriage bolts, respectively, for aligning bores of the bearings.

16. The header of claim 12, wherein the sensor is connected to the rod by an adjustable linkage.

17. The header of claim 12, wherein at least one of the mounting brackets is mounted to the frame with a spacer therebetween for aligning a bore of the bearing on the free end of the bracket with the bearings on others of the brackets.
